(19) United States
(12) Patent Application Publication
(10) Pub. No.: US 2008/0027945 A1
(43) Pub. Date: Jan. 31, 2008

(54) Methods, systems and computer program products for downloading a Java application based on identification of supported classes

(76) Inventor: Paul H. Nichols, Raleigh, NC (US)

Correspondence Address: MYERS BIGEL SIBLEY & SAJOVEC, P.A., P.O. BOX 37428, RALEIGH, NC, 27627, US

(21) Appl. No.: 11/495,982

(22) Filed: Jul. 28, 2006

(51) Int. Cl. G06F 17/30

(52) U.S. Cl. 707/10

(57) ABSTRACT

Methods for controlling downloading of a Java application to a mobile terminal include receiving a request to download the Java application to the mobile terminal. A descriptor associated with the Java application is downloaded. An API attribute list identified in the descriptor is retrieved from the descriptor when available. The API attribute list identifies all Java class files referenced by the Java application. The API attribute list is compared to a list of Java class files supported by the mobile terminal to determine if the mobile terminal supports the Java application. Downloading of the Java application is controlled based on the comparison of the API attribute list to the list of Java class files supported by the mobile terminal, including downloading the Java application when the mobile terminal supports the Java application and notifying a user of the mobile terminal that the mobile terminal does not support the Java application when the mobile terminal does not support the Java application.

### BACKGROUND OF THE INVENTION

The present invention relates to methods, systems and computer program products for downloading applications and, more particularly, to methods, systems and program products for downloading Java applications.

A wide variety of data processing devices have been introduced that are capable of communicating with each other across different types of networks. In addition, various wired and wireless networks are operated using standards allowing communication between different devices on different networks using protocols, such as the Internet protocol (IP). A common approach to such communications involves the client-server model, where the client typically runs a browser application that requests and receives data from remote server applications. The downloaded data from the server devices in a client-server relationship model may be in the form, for example, of hypertext mark-up language (HTML) pages, which may include embedded Java applications.

Java applications may also be downloaded and/or installed on a variety of client devices from a server device by other means. Java applications are often utilized in such a network environment as the applications are generally not linked to a specific type of platform hardware or operating system. Furthermore, Java applications generally have an associated set of standard packages/libraries, which may provide functionality usable across different Java applications. As such, a common Java application may be run across a variety of processing platforms.

For any particular hardware platform, such as a mobile terminal, Java applications may be provided by the vendor of the platform, which Java applications are generally fully supported by the hardware platform so that a user will typically encounter no problems in downloading and installing such vendor-provided Java applications on the mobile terminal. However, it is generally also possible, with various computing platforms, to download and install third party Java applications not provided by the vendor of the platform. As a result, Java applications may be downloaded from numerous sources. Such downloaded Java applications generally require certain application programming interfaces (APIs) or Java classes to be supported by the hardware platform or the downloaded Java application will generally not be successfully run. The required APIs may be specified by a Java package/library and/or by Java class. Examples of required APIs include Mobile Information Device Profile (MIDP), various Java Specification Requests (JSRs), operator specific APIs, such as Nokia Sound and the like.

If a Java application is installed on a device that does not support all of the required APIs, then the application will generally fail to run. Such a failure after download of a Java application is generally not observed by a user until run time after the application has been downloaded, installed and started. Sometimes such failures might not occur until the application is started and the user accesses a particular feature of the application that requires an unsupported API. As such, a user may experience wasted time in downloading and installing of a non-functioning application. As a result, the user may be frustrated and could develop a negative impression of the device onto which the Java application was downloaded.

### SUMMARY OF THE INVENTION

Embodiments of the present invention include methods for controlling downloading of a Java application to a mobile terminal. A request is received to download the Java application to the mobile terminal. A descriptor associated with the Java application is downloaded. An API attribute list identified in the descriptor is retrieved. The API attribute list identifies all Java class files referenced by the Java application. The API attribute list is compared to a list of Java class files supported by the mobile terminal to determine if the mobile terminal supports the Java application. Downloading of the Java application is controlled based on the comparison of the API attribute list to the list of Java class files supported by the mobile terminal. Controlling downloading includes downloading the Java application when the mobile terminal supports the Java application and notifying a user of the mobile terminal that the mobile terminal does not support the Java application when the mobile terminal does not support the Java application.

In some embodiments, retrieving an API attribute list identified in the descriptor includes downloading a Java class file included in the Java application based on an identification retrieved from the descriptor and retrieving the API attribute list from the downloaded Java class file. In other embodiments, retrieving an API attribute list identified in the descriptor comprises retrieving an API attribute list included in the descriptor.

In further embodiments, when it is determined that the descriptor does not include the API attribute list, the Java application is downloaded. All Java class files associated with the Java application are identified and the identified Java class files are formatted to generate a validation API attribute list. Comparing the API attribute list in such embodiments includes comparing the validation API attribute list to the list of Java class files supported by the mobile terminal to determine if the mobile terminal supports the Java application.

In other embodiments, identifying all Java class files associated with the Java application includes identifying all Java class files contained in the Java application and identifying all Java class files referenced in the Java class files contained in the Java application. The descriptor may be a Java Application Descriptor (JAD) and the Java application may include a Java Archive (JAR) file and identifying all Java class files contained in the Java application may include identifying all Java class files contained in the JAR file. Identifying all Java class files contained in the JAR file may include inspecting a constant pool field, a super class field and an interfaces field of all the Java class files contained in the JAR file. Formatting the identified Java class files to generate a validation API attribute list may include generating the API attribute list to identify the referenced Java class files without identifying the Java class files contained in the Java application.

In further embodiments, identifying all Java class files contained in the Java application includes generating a list of all Java class files contained in the Java application and identifying all Java class files referenced in the Java class files contained in the Java application is preceded by initializing a list of all required classes and a list of all required bundles to an empty set. Formatting the identified Java class files comprises, for each referenced Java class file: determining if the referenced Java class file is included in the list of all Java class files contained in the Java application; determining if the referenced Java class file is included in any bundle included in the list of all required bundles when the referenced Java class file is not included in the list of all Java class files contained in the Java application; determining if the referenced Java class file is included in a bundle known to (i.e., supported by) the mobile terminal when the referenced Java class file is not included in any bundle included in the list of all required bundles; adding the bundle known to the mobile terminal to the list of all required bundles when it is determined that the referenced Java class file is included in the bundle known to the mobile terminal; and adding the referenced Java class file to the list of all required classes when it is determined that the identified Java class file is not included in any bundle included in the list of all required bundles or in a bundle known to the mobile terminal or in the list of all Java class files contained in the Java application. Formatting the identified Java class files further includes generating the validation API attribute list based on the list of required bundles and the list of required classes. The list of required bundles and/or the list of known bundles may include an identification of Java packages.

In yet other embodiments, the identified Java class files have an associated version and adding the identified Java class file to the list includes adding an identification of the associated version. Determining if the identified Java class file is included in any bundle included in the list of all required bundles and determining if the identified Java class file is included in a bundle known to the mobile terminal are based on the associated version. Adding an identification may include adding a method type signature associated with the identified Java class file.

In further embodiments, the identified Java class files are identified as optional or required and downloading the Java application when the mobile terminal supports the Java application includes automatically downloading the Java application when the mobile terminal supports all the required and all the optional identified Java class files. Downloading the Java application when the mobile terminal supports all the required identified Java class files and less than all the optional identified Java class files includes notifying the user of the mobile terminal that the Java application may be downloaded with limited functionality before downloading the Java application. Notifying the user of the mobile terminal that the mobile terminal does not support the Java application includes notifying the user of the mobile terminal that the mobile terminal does not support the Java application when the mobile terminal supports less than all of the required identified Java class files.

In other embodiments, downloading the Java application when the JAD does not include the API attribute list is preceded by comparing any bundles identified by a field included in the downloaded descriptor to the list of Java class files supported by the mobile terminal. The Java application is not downloaded and the user is notified the mobile terminal does not support the Java application when any bundles identified by the field included in the downloaded descriptor are not included in the list of Java applications supported by the mobile terminal.

In further embodiments, the list of Java class files supported by the mobile terminal includes at least one bundle identification and the API attribute list includes at least one bundle identification. Comparing the API attribute list includes comparing the at least one bundle identified in the API attribute list to the at least one bundle identified in the list of Java class files supported by the mobile terminal. In other words, the identification of Java class files supported by the mobile terminal may be provided by identification of Java packages and/or bundles.

In yet other embodiments, methods for generating an API attribute list for a Java application include obtaining a list of known bundles that identifies all classes known to the respective known bundles, initializing a list of all required classes and a list of all required bundles to an empty set and identifying all Java class files referenced by the Java application. The identified Java class files are formatted to generate the API attribute list. Formatting the identified Java class files includes, for each identified Java class file: determining if the identified Java class file is contained in the Java application; determining if the identified Java class file is included in any bundle included in the list of all required bundles when the identified Java class file is not contained in the Java application; determining if the identified Java class file is known to a listed one of the known bundles in the list of known bundles when it the identified Java class file is not included in any bundle included in the list of all required bundles; adding the listed one of the known bundles to the list of all required bundles when it is determined that the identified Java class file is known to the listed one of the known bundles and is not contained in the Java application; and adding the identified Java class file to the list of all required classes when it is determined that the identified Java class file is not included in any bundle included in the list of all required bundles or known to a listed one of the known bundles or contained in the Java application. Formatting the identified Java class files may further include generating the API attribute list based on the list of required bundles and the list of required classes. The Java application may include a Java Application Descriptor (JAD) and a Java Archive (JAR) file and identifying all Java class files contained in the Java application may include identifying all Java class files contained in the JAR file and generating the API attribute list may be followed by incorporating the API attribute list in the JAD. Identifying all Java class files referenced by the Java application may include identifying the Java class files contained in the Java application and identifying all Java class files referenced in the Java class files contained in the Java application.

In further embodiments, a mobile terminal includes a user interface configured to receive a user request to download a Java application and to notify a user when the mobile terminal does not support a requested Java application. The mobile terminal further includes a communication interface configured to download the Java application responsive to the user request and a list of Java class files supported by the mobile terminal. In addition, the mobile terminal includes a controller configured to identify all Java class files required by the Java application and to control downloading of the Java application using the communication interface based on a comparison of the list of Java class files supported by the mobile terminal and the Java class files required by the Java application, including downloading the Java application when the list of Java class files supported by the mobile terminal includes all identified Java class files required by the Java application and providing a notification to the user through the user interface when the list of Java class files supported by the mobile terminal does not include all identified Java class files required by the Java application.

In other embodiments, the controller is configured to identify all Java class files required by the Java application by downloading a descriptor associated with the Java application using the communication interface and to retrieve an API attribute list included in the descriptor, the API attribute list identifying all Java class files required by the Java application. The controller may be configured to download the Java application using the communication interface when the descriptor does not include the API attribute list and to generate the API attribute list from the downloaded Java application.

In yet other embodiments, a computer system for generating an API attribute list for a Java application includes a list of known bundles that identifies all classes known to the respective known bundles, a list of all required classes and a list of all required bundles. The computer system further includes a required class identification module configured to identify all Java class files referenced by the Java application and an API attribute list generation module. The API attribute list generation module is configured to initialize the list of all required classes and the list of all required bundles to an empty set and to format the identified Java class files by, for each identified Java class file: 1) determining if the identified Java class file is included in any bundle included in the list of all required bundles; 2) determining if the identified Java class file is known to a listed one of the known bundles in the list of known bundles when the identified Java class file is not included in any bundle included in the list of all required bundles; 3) adding the listed one of the known bundles to the list of all required bundles when it is determined that the identified Java class file is known to the listed one of the known bundles and is not a Java class file contained in the Java application; and 4) adding the identified Java class file to the list of all required classes when it is determined that the identified Java class file is not included in any bundle included in the list of all required bundles or known to a listed one of the known bundles or contained in the Java application and to generate the API attribute list based on the list of required bundles and the list of required classes.

In yet further embodiments, a Java application file is provided. The Java application file includes a plurality of Java class files and a Java application descriptor file. The Java application descriptor file includes an identification of all Java class files required by the Java application file that are not otherwise identified in the Java application descriptor file.

In other embodiments, a Java application file is provided. The Java application file includes a plurality of Java class files. The Java application file further includes an API attribute list in at least one of the Java class files that identifies Java class files required by the Java application file, including Java class files referenced by at least one other of the Java class files and not by the at least one Java class file including the API attribute list.

### BRIEF DESCRIPTION OF THE DRAWINGS

FIG. 1 is a block diagram of a data processing system suitable for use in some embodiments of the present invention.

FIG. 2 is a block diagram of a communication system according to some embodiments of the present invention.

FIG. 3 is a flowchart illustrating downloading a Java application according to some embodiments of the present invention.

FIG. 4 is a flowchart illustrating generating an API attribute list according to some embodiments of the present invention.

FIG. 5 is a flowchart illustrating downloading a Java application according to other embodiments of the present invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present specification and will not be interpreted in an idealized or overly formal sense unless expressly so defined herein.

As used herein, a “terminal” includes both devices having only a wireless signal receiver without transmit abilities and devices having both receive and transmit hardware capable of two-way communication over a two-way communication link. Such devices may include cellular or other communications devices with or without a multi-line display; Personal Communications System (PCS) terminals that may combine a voice and data processing, facsimile and/or data communications capabilities; Personal Digital Assistants (PDA) that can include a radio frequency receiver and a pager, Internet/Intranet access, Web browser, organizer, calendar and/or a global positioning system (GPS) receiver; and/or conventional laptop and/or palmtop computers or other appliances, which include a radio frequency receiver. As used herein, “mobile terminals” may be portable, transportable, installed in a vehicle (aeronautical, maritime, or land-based), or situated and/or configured to operate locally and/or in a distributed fashion at any other location(s) on earth and/or in space.

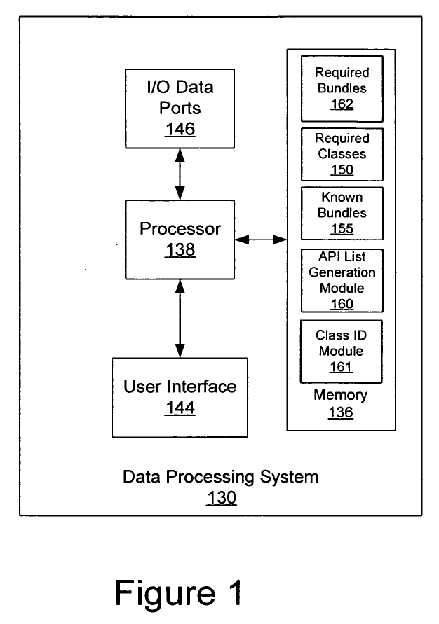

Referring now to FIG. 1, an exemplary embodiment of devices, for example, a personal computer system or the like or other data processing system 130 configured in accordance with some embodiments of the present invention will be discussed. The data processing system 130, which may be incorporated in, for example, a personal computer, a server computer, a PDA, a wireless terminal/phone, or the like, may include a user interface 144, including, for example, input device(s) such as a keyboard or keypad, a display, a speaker and/or microphone, and a memory 136 that communicate with a processor 138. The data processing system 130 may further include an I/O data port(s) 146 that also communicate with the processor 138. The I/O data ports 146 can be used to transfer information between the data processing system 130 and another computer system or a network that may be associated with a service provider or user communication devices using, for example, an Internet Protocol (IP) connection. These components may be conventional components such as those used in many conventional data processing systems, which may be configured to operate as described herein.

As shown in the embodiments of FIG. 1, the memory 136 includes a list of required bundles 162, a list of required classes 150, a list of known bundles 155, an API list generation module 160 and a required class identification module 161. While shown as resident in the memory 136 in the embodiments of FIG. 1 it will be understood that the respective database and module features, including the API list generation module 160 and the class identification module 161, may be implemented, for example, as part of the operating system, as application programs, as components of a dynamic link library or the like of the data processing system 130 so as to be executed in whole or in part by the processor 138. Accordingly, the particular grouping of modules illustrated in FIG. 1 is solely for the purposes of explanation of the present invention.

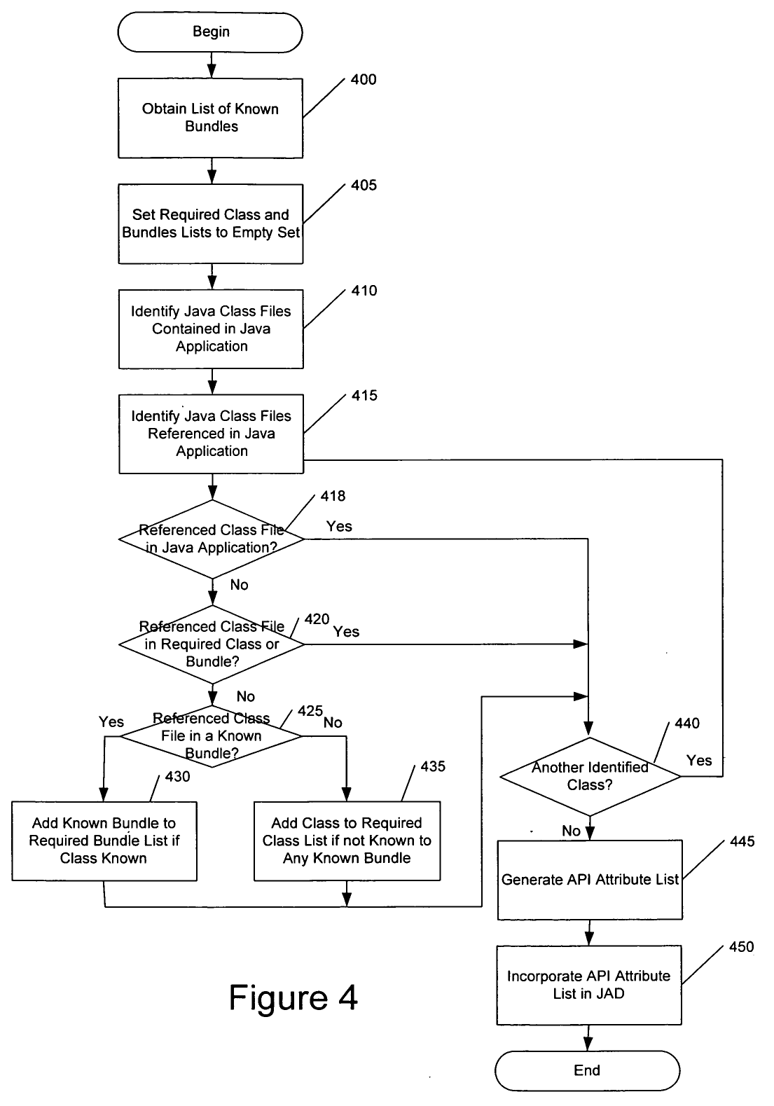

In some embodiments of the present invention, the API attribute list generation module 160 is configured to initialize the list of all required classes 150 and the list of all required bundles 162 to an empty set and to format and identify a group of Java class files associated with the Java application as an API attribute list, which may be included with a descriptor associated with the Java application. More particularly, the API attribute list generation module 160 may be configured to generate the API attribute list by carrying out operations as will be described with reference to FIG. 4.

In some embodiments of the present invention, the class identification module 161 is configured to identify all Java class files associated with a Java application. The class identification module 161 may be configured to identify all Java class files contained in a Java application and to identify all Java class files referenced in the Java class files contained in the Java application. As will be described for some embodiments herein, the Java class files contained in the Java application need not be included in the API attribute list as they are contained in the application and, thus, supported by a downloading device once the Java application is downloaded. Similarly, a referenced Java class file that is also contained in the Java application also need not be included in the API attribute list.

By way of background, a Java class file generally contains executable byte codes. For example, a J2ME Java application is typically stored in a Java architecture (JAR) file, which generally contains several class files and other resources. Inside each class file there is generally included information about any other classes that are referenced by the class. As such, a list of required classes, in some embodiments of the present invention, may be generated by inspecting fields in the JAR file, such as constant pool, super class, interfaces and fields.

It will further be understood that, in some embodiments, there may be one or more different versions of any given recorded Java class. The implementation of a class may be different from device to device and different class implementations or versions may support different public and protected methods and fields. As such, in some embodiments of the present invention, the required class identification module 161 further determines the version of the required classes. Such information may be available as a method/field signature for a class or bundle definition.

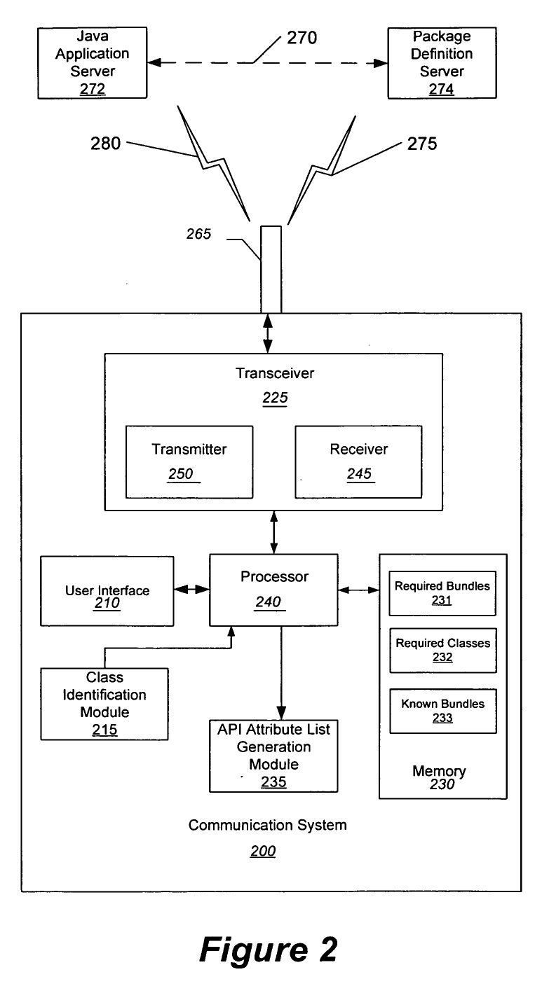

A communication system, such as a mobile terminal, in according to some embodiments of the present invention will now be described with reference to the block diagram illustration of FIG. 2. As shown in the embodiments of FIG. 2, a communication system 200 configured to download Java applications may include a network transceiver 225 for communicating with other terminals, servers and the like. The network transceiver 225 typically comprises a transmitter circuit 250 and a receiver circuit 245, which respectively transmit outgoing radio frequency signals to servers 272, 274 and receive incoming radio frequency signals from the servers 272, 274 via an antenna 265. While a single antenna 265 is shown in FIG. 2, it is to be understood that multiple antennas and/or different types of antennas may be utilized based on the types of signals being received. The radio frequency signals transmitted between the communication system 200 and the servers 272, 274 may comprise both traffic and control signals (e.g., paging signals/messages for incoming calls), which are used to establish and maintain communication with another party or destination, and may provide uplink and/or downlink communications.

As further shown in the embodiments of FIG. 2, the communication system 200 includes a processor 240 coupled to the transceiver 225. The processor 240 is also coupled to a memory 230 that may be used to store data, programs and the like used by the processor 240 in carrying out operations as will be described further herein. In addition, a variety of operational circuits are shown coupled to the processor 240, including a required class identification module 215 and an API attribute list generation module 235. While shown as separate modules in the embodiments of FIG. 2, it will be understood that, in various embodiments of the present invention the modules 215, 235 may be implemented in whole or in part as programmable code stored in the memory 230 and executed by the processor 240.

In some embodiments of the present invention, API list generation module 160 and the required class identification module 215 may be configured to operate on Java applications downloaded to the communication system 200 substantially as described previously for the required class identification module 161. Similarly, API attribute list generation module 235 may be configured to operate on Java applications downloaded to the communication system 200 substantially as described previously for the API list generation module 160. As also shown in the embodiments of FIG. 2, the memory 230 includes a list of required bundles 231, a list of required classes 232 and a list of known bundles 233, which may be configured and used substantially as described previously with reference to the list of required bundles 162, the list of required classes 150 and the list of known bundles 155.

While embodiments of the present invention have been illustrated in FIG. 2 with reference to particular divisions between modules, the present invention should not be construed as limited to the configurations of FIG. 2 but is intended to encompass any configuration capable of carrying out the operations described herein. Furthermore the functionality described herein may be provided, for example by plug-ins or other ancillary code to provide functionality to existing applications.

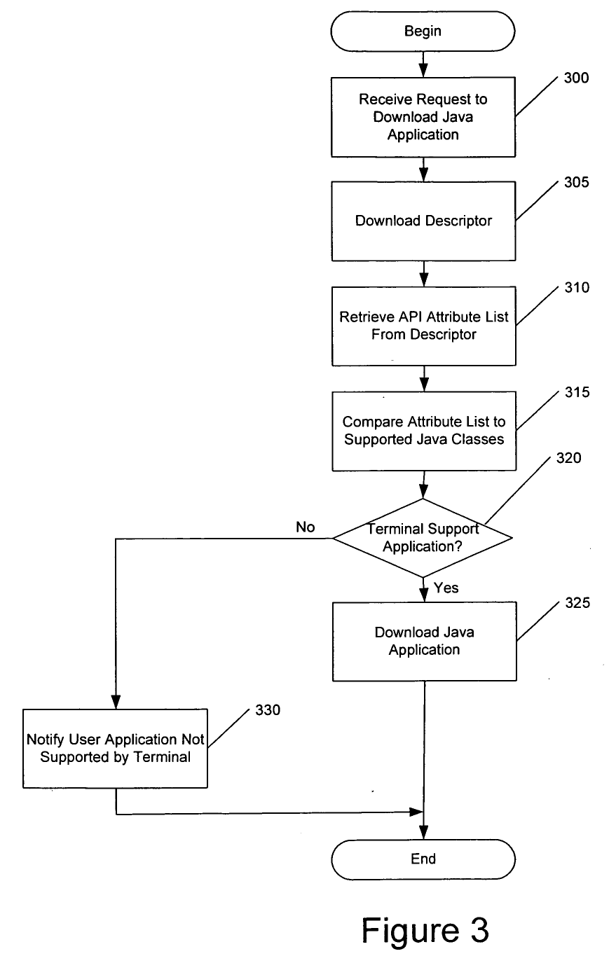

Operations for controlling downloading of a Java application according to some embodiments of the present invention will now be described with reference to the flowchart illustration of FIG. 3. For the embodiments illustrated in FIG. 3, operations begin by receiving a request to download the Java application to a mobile terminal or the like (block 300). A descriptor associated with the Java application is downloaded (block 305). For example, in some embodiments, the descriptor is a Java application descriptor (JAD).

An API attribute list included in the descriptor is retrieved (block 310). The API attribute list identifies all Java class files referenced by the Java application. For example, in some embodiments of the present invention, the API attribute file is added to the application's JAD file. The API attribute list may provide a list of all the required APIs (classes) for a given Java application, such as a MIDlet. As will be further described herein, the list of APIs can be generated automatically by a server, which analyzes each of the class files in a JAR file or the like. For example, an API attribute list might include the following: java.lang.Boolean, java.lang.Byte, . . . , javax.microedition.midlet.MIDlet, javax.microedition.io.Connection, . . . , javax.microedition.media.Player, . . . com.mascotcapsule.micro3d.v3.Vector3D.

It will be further understood that the listed APIs or identification of Java classes will typically include one or more package identifications, where the package identifies a corresponding set of classes. It is known to organize Java classes into packages. Examples of such known Java class packages include java.io, com.sun.io, and com.sonyericssonj2me.sdk. Such packages (sometimes referred to as libraries) are a way of grouping related classes. A class is generally uniquely identified by its fully qualified class name, which typically includes the package name followed by the class name. For example, java.io.InputStream identifies the InputStream class that is a member of the java.io package. The term “bundle” as used herein includes, but is not limited to, Java packages.

The use of bundle identification, rather than individual listings of every class in the API attribute list, may potentially provide a significant reduction in the length of the API attribute list, which has a potential to be fairly lengthy as it lists out every single class that is referenced by the Java application. Thus, to shorten the length of the attribute list, the concept of API bundles may be utilized. For example, the Mascot Capsule v3 API typically includes the following classes: ActionTable, AffineTrans, Effect3D, Figure, FigureLayout, Graphics3D, Light, Texture, Util3D, Vector3D. Instead of listing each individual class, the set of classes may be referenced as a bundle. An example bundle identification is: com.mascotcapsule.micro3d.v3.[REVA], where the [REVA] refers to a specific revision of the API which includes a set of classes. By way of further example, if an application requires CLDC1.1 and MIDP2.0, the API attribute may be set to Javax.microedition.[CLDC1.1], javax.microedition.[MIDP2.0] that will refer to all the classes in the Java and Javax packages that are required.

The retrieved API attribute list is compared to a list of Java class files supported by the mobile terminal to determine if the mobile terminal supports the Java application (block 315). Operations for controlling downloading of the Java application based on the comparison at block 315 will now be described with reference to blocks 320 to 330. If the terminal supports the application (block 320), the Java application is downloaded (block 325). If the mobile terminal does not support the Java application (block 320), a user of the mobile terminal is notified that the mobile terminal does not support the Java application (block 330).

Methods for generating an API attribute list for a Java application according to some embodiments of the present invention will now be described with reference to the flowchart illustration of FIG. 4. As shown in the embodiments of FIG. 4, operations begin by obtaining a list of known bundles that identifies all classes known to the respective bundles (block 400). In other words, a device or server generating the API attribute list may have or obtain bundle information from a variety of different provider sources, including an identification of all classes known to such bundles. A list of all required classes and a list of all required bundles are initialized to an empty set (block 405).

Operations related to identifying all Java class files associated with the Java application will now be described with reference to blocks 410 and 415 are identified (block 410). All Java class files contained in the Java application are identified (block 410). All Java class files referenced in the Java class files contained in the Java application are also identified (block 415). Operations as will now be described with reference to blocks 418 through 440 are then carried out for each referenced Java class file identified at block 415.

In particular embodiments of the present invention, the Java application is stored in a Java archive (JAR) file, which contains several Java class files and other resources. In addition, inside each class file may be information about any other classes that are referenced by the listed classes. More particularly, in some embodiments of the present invention, the list of required classes obtained at block 410 and block 415 may be derived by inspecting fields of a class file in a JAR file, including constant pool, super class, interfaces, and fields.

Operations for formatting the identified Java class files to generate the API attribute list will now be described with reference to blocks 418 to 440 for some embodiments of the present invention. The operations at blocks 418 through 440 in some embodiments are carried out for each referenced Java class file identified at block 415. It will be understood that formatting operations as described with reference to blocks 418 to 440 may be performed with or without making a change to the Java class files. Fore example, when the API identifier is placed in the JAD file then no modification to Java class files may be made. However, a similar API identifier attribute could optionally also be placed within each of the Java class files and used to, for example, speed the process of generating the API attribute list when it is not present in the JAD file. In any event, the process for identifying required classes need not include changing the class files.

Referring now to FIG. 4, for an identified referenced Java class file, it is determined if the referenced Java class file is also a class file contained in the Java application (block 418). If not (block 418), operations at blocks 425 to 435 may be skipped. Otherwise, if the referenced Java class file is not a Java class file included in the Java application (block 418), it is determined if the identified Java class file is included in any bundle included in the list of required bundles or class included in the list of required classes (block 420). When the identified Java class file is not included in any bundle including the list of all required bundles or any class included in the list of required classes (block 420), it is determined if the identified Java class file is known to a listed one of the known bundles in the list of known bundles (block 425). Otherwise (block 420), operations move to block 440.

When it is determined that the identified Java class file is known to the listed one of the known bundles (block 425), the listed one of the known bundles is added to the list of all required bundles (block 430). When it is determined that the identified Java class file is not known to a listed one of the known bundles (block 425), the identified Java class file is added to the list of all required classes (block 435). If there are additional identified referenced classes (block 440), operations at block 418 through block 440 repeat.

The API attribute list for a Java class is generated based on the list of required bundles and the list of required classes (block 445). The API attribute list may be incorporated in the descriptor, such as the JAD (block 450). The API attribute list may be inserted into the Java class file. For example, inserting the API attribute list into the class file may be desirable in some embodiments when a JAD is not present and the Java application is downloaded over a network one class at a time. This may allow the downloading device to determine if the application can be supported by the device after downloading only a single class file, namely the class file that contains the application entry point.

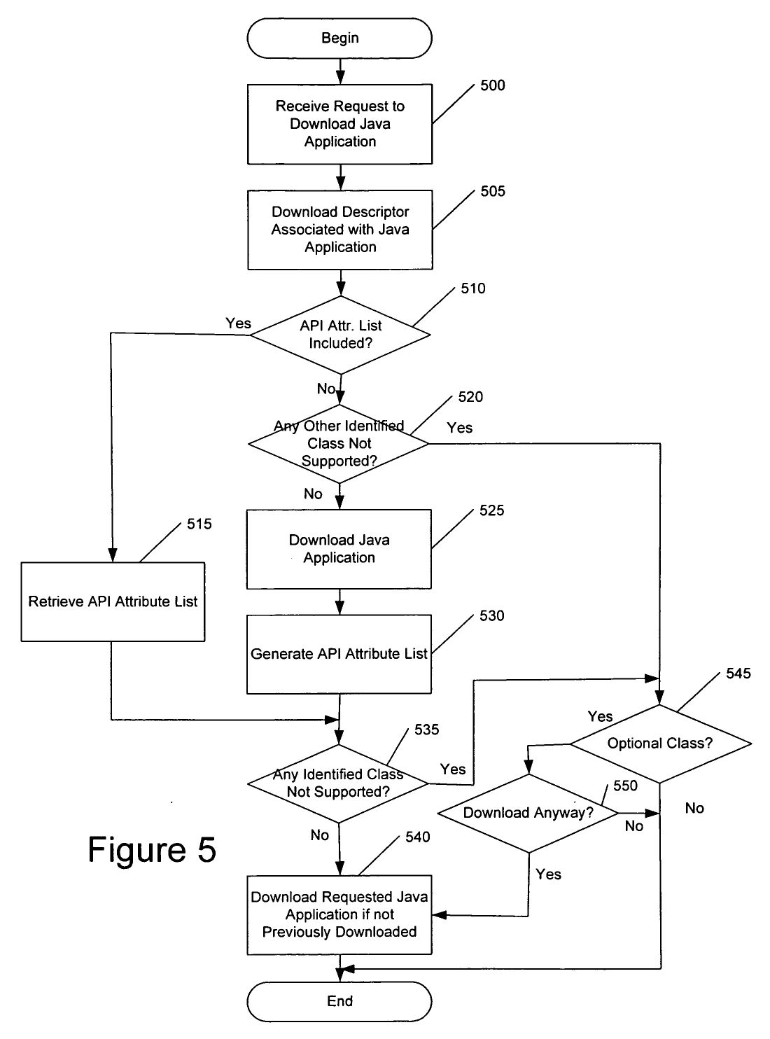

Methods for controlling downloading of a java application to a mobile terminal according to further embodiments of the present invention will now be described with reference to the flowchart illustration of FIG. 5. It will be understood that, while a variety of different operations are shown with reference to respective boxes in FIG. 5, particular embodiments of the present invention may include different combinations of such operations and all such operations need not be included in other embodiments of the present invention. For the particular embodiments illustrated in FIG. 5, operations begin with receipt of a request to download the java application to the mobile terminal or the like (Block 500). A descriptor, such as a JAD, associated with the Java application is downloaded (Block 505).

Operations for controlling downloading will be further described with reference to the remaining blocks of FIG. 5. If the downloaded descriptor includes the API attribute list (Block 510), the API attribute list is retrieved (Block 515). If the descriptor does not include the API attribute list (Block 510), it is determined if any bundles identified by a field of the downloaded descriptor other than the API attribute list are included in a list of Java class files supported by the mobile terminal requesting downloading of the Java application to determine if the mobile terminal supports the Java application (Block 520).

For example, the Java application descriptor (JAD) file generally contains attributes of MicroEdition-Configuration and MicroEdition-Profile that indicate the required configuration and profile support. For example, CLDC 1.0, CLDC 1.1, MIDP 1.0 and MIDP 2.0. These field designations may provide information about the core APIs (classes) that are required, although many applications require additional APIs above and beyond CLDC and MIDP. Nonetheless, as described herein and performed at Block 520, for some embodiments of the present invention, it is possible to imply a required bundle from standard configuration and profile attributes (such as CLDC 1.0, CLDC 1.1, MIDP 2.0 and/or MIDP 1.0) that are found in other fields of the downloaded descriptor. This may be used to reduce the length of the generated API attribute list by not re-identifying such bundles in the API attribute list and/or may be used to avoid unnecessary downloading of the JAVA application in some embodiments of the present invention when the API attributes list is not already present as will be further described with reference to Blocks 545, 550 and 540.

If no required bundle not supported by the downloading device is identified by reviewing the other fields in the descriptor (Block 520), the Java application itself is downloaded (Block 525). As such, once the Java application is downloaded at Block 525, the downloading device may itself generate the API attribute list in a manner such as described previously for generating an API attribute list for including in the descriptor with reference to the embodiments of FIG. 4. As such, the downloading device may generate the API attribute list at Block 530 so as to establish a validation API attribute list on the downloading device to make an assessment as described with reference to FIG. 3 as to whether the Java application is supported by the device. In other words, when the API attribute is missing from the JAD file, then the configuration and profile APIs may still be checked prior to downloading the JAR file at Block 520 and 525. While downloading of a JAR file or Java application may avoid the benefits of reduced need for downloading of unsupported applications, nonetheless, prior to installing the applications, the downloading device may still inspect the classes in the JAR file and determine if all of the required classes are supported by the downloading device. A similar API support check can also be performed prior to installing the application. If such a validation API check fails, the user can be informed that the application is not compatible (i.e., the required APIs or classes are not available) with the device. Thus, while the Java application that is not supported may still be downloaded, a user may be provided a better view of the performance of the device by notifying the user that the application is not compatible before the user attempts to install and operate the Java application.

Some embodiments may differ based on whether a server or client device generates the API attribute list. For example, a client device will typically know exactly what it supports. The server in some embodiments knows the super set of what is supported by different possible downloading client devices and may then perform a best fit operation when generating the API attribute list. In other words, a class might be included in several bundles and, when selecting among several bundles, the one that includes the least number of classes may be chosen first. If, subsequently, a second bundle is added that is a super set of a previously added bundle, the second bundle can replace the first bundle and/or extra information about which device the application is targeted for may be provided. Furthermore, while the API attribute (for the entire application) may be missing from the JAD file, this information may have been added inside of the individual Java class files, which may make it easier for the mobile client to produce the API attribute list.

For some Java applications, referenced classes associated with the Java application may be both required and/or optional APIs (classes). In other words, an identified Java class or API may be optional, although performance and features of the Java application may be changed and/or limited where an optional API/class is not supported. Thus, in some embodiments of the present invention, a distinction may be made between required and optional API/classes as will now be described with reference to Blocks 535-550. For such embodiments, the generated API attribute list or the like provides the necessary information to the downloading device or the server generating the API attribute list to allow designation of a particular listed class/API as optional or required.

As seen in the embodiments of FIG. 5, any not supported identified class at Block 520 or Block 535 is further assessed to determine whether it is optional (Block 545). If an identified class or bundle is optional (Block 545) it is determined whether the Java application should be downloaded anyway, in other words, in spite of the fact that identified optional classes are not supported by the downloading device (Block 550). For example, in some embodiments of the present invention, operations at Block 550 include notifying a user of the mobile terminal that the Java application may be downloaded with limited functionality before downloading the Java application. Downloading may then proceed automatically or may be made contingent upon a selection by the user that downloading of a limited functionality application is desired. In some embodiments, the downloading device may be configured to make the download decision on a predetermined set of rules, such as a user selection in advance to proceed or not to proceed with downloading of Java applications where optional class/APIs are not supported. If the application for which optional classes are not support is to be downloaded (Block 550), the requested Java application is downloaded if not previously downloaded (Block 540). Similarly, if there are no unsupported classes identified (Block 535), the requested Java application is downloaded at Block 540 if not previously downloaded. In other words, if the Java application file has been downloaded at Block 525, it need not be downloaded again at Block 540.

It will be further understood that, in some embodiments, the identified Java class files have an associated version and a listing of required classes and bundles may include a corresponding identification of the associated version. Operations related to determining if an identified Java class file is included in any bundle or included in a bundle known to the mobile terminal may similarly be based on the associated version number. In other words, a class or bundle may be known to the downloading device but only in a version number that is earlier than the version of the class and/or bundle that has been identified as being required by the Java application that is to be downloaded. Accordingly, where the version number does not match, the Java application may be identified as not supported by the downloading device because the required version number is not supported. For example, the method/field signature may be associated with a listed bundle or class definition to ensure that the correct version of the class identified in a Java application to be downloaded is supported by the downloading device. This may be represented in the API attribute list and in the bundle definition as a list of methods with the method's type signature (the type and/or order and/or parameters).

Thus, a modified install process may be provided in accordance with some embodiments of the present invention, where the downloading device receives a user selection of an application to be downloaded and begins the downloading/transferring of the application to the downloading device, including first downloading a descriptor file, such as a JAD file containing an API attribute. The downloading device may read the JAD file and compare bundles and/or Java libraries listed in the API attribute list with a set of bundles and/or Java libraries supported by the downloading device. If the downloading device does not support all of the required APIs, then a user may be informed that the application is not compatible with this downloading device and the install process may be ceased. If the downloading device does not support all of the optional APIs, then the user may be informed that the application can be installed but will have limited functionality as not all APIs are supported. If the downloading device does support all required and optional APIs, then downloading may be continued of the Java application, such as the JAR file and installing of the application. The install process may then continue as normal. Where an API attribute list is not present in the descriptor JAD file, some embodiments proceed with normal installation without verification of compatibility or modified install processes may proceed as described with reference to Blocks 525 and 530 by generating a validation API attribute list for checking on the downloading device itself.

Thus, as described above with reference to various embodiments, some embodiments of the present invention provide for identifying unsupported applications prior to downloading, installing and running an application. Such operations may limit or prevent end user frustration from experience of non-functioning applications and the potentially wasted time and resources associated with downloading and installing non-functional applications.

As generally described above, when beginning generation of the API attribute list for a given Java application, a list of required bundles and a list of required classes are first set to an empty set so that they may be built up with identifications of all required class and bundle identifications for a particular Java application. Known bundle information is also obtained to allow for a potential reduction in length and size of the API attribute list by using bundle identifications rather than individual class identification listing for every class. For some particular embodiments, a registry of known bundles may be maintained so that when new API bundles are defined, they may be standardized and version controlled. For example, placing this information on a common server may be provided so that application servers, application developers, and/or device manufacturers can update and/or reference such bundle information.

Further, as described above, in some embodiments a JAR file for a Java application may be read to create a list of all class files contained in the JAR file and, for each class in the JAR file, the class may be inspected and a list of referenced classes may be created. For each referenced class, it may be determined if the referenced class is already included in the list of classes contained in the JAR file and, if so, to avoid redundancy, operations may skip to the next class. It is further determined if the referenced class is included in any of the bundles in the list of required bundles and, if so, the reference class may be skipped. If the referenced class is included in any of the bundles listed in the list of known bundles, then the bundle may be added to the list of required bundles. If the referenced class is not already in the list of required classes, nor is it associated with any known or listed required bundle, it may be added to the list of required classes. In other words, classes referenced or associated with the Java application file may be preferentially included in an API attribute list as part of a known bundle/library to which the class is known and, if no such known bundle is available, may be listed individually in the API attribute list file. Thus, as described above, a server or other device can generate the API attribute list for an existing Java application and add this attribute list to a descriptor, such as a JAD file, without the need for human intervention.

As will be appreciated by one of skill in the art, the present invention may be embodied as a method, system, mobile terminal or computer program product. Accordingly, the present invention may take the form of an entirely hardware embodiment, an entirely software embodiment or an embodiment combining software and hardware aspects, all generally referred to herein as a “circuit” or “module.”

Computer program code for carrying out operations of the present invention may be written in an object oriented programming language such as Java®, Smalltalk or C++, a conventional procedural programming languages, such as the “C” programming language, or lower-level code, such as assembly language and/or microcode. The program code may execute entirely on a single processor and/or across multiple processors, as a stand-alone software package or as part of another software package.

The present invention is described above with reference to flowchart illustrations and/or block and/or flow diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart and/or block and/or flow diagram block or blocks.

These computer program instructions may also be stored in a computer-readable memory that can direct a computer or other programmable processor to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processor to cause a series of operational steps to be performed on the computer or other programmable processor to produce a computer implemented process such that the instructions which execute on the computer or other programmable processor provide steps for implementing the functions or acts specified in the flowchart and/or block diagram block or blocks.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A method for controlling downloading of a Java application to a mobile terminal, the method comprising:
receiving a request to download the Java application to the mobile terminal;
downloading a descriptor associated with the Java application;
retrieving an API attribute list identified in the descriptor, the API attribute list identifying all Java class files referenced by the Java application;
comparing the API attribute list to a list of Java class files supported by the mobile terminal to determine if the mobile terminal supports the Java application; and
controlling downloading of the Java application based on the comparison of the API attribute list to the list of Java class files supported by the mobile terminal including downloading the Java application when the mobile terminal supports the Java application and notifying a user of the mobile terminal that the mobile terminal does not support the Java application when the mobile terminal does not support the Java application.

2. The method of claim 1, wherein retrieving an API attribute list identified in the descriptor comprises:
downloading a Java class file included in the Java application based on an identification retrieved from the descriptor; and
retrieving the API attribute list from the downloaded Java class file.

3. The method of claim 1, wherein retrieving an API attribute list identified in the descriptor comprises retrieving an API attribute list included in the descriptor.

4. The method of claim 3, the further comprising determining that the descriptor does not include the API attribute list and wherein controlling downloading includes the following when the descriptor does not include the API attribute list:
downloading the Java application;
identifying all Java class files associated with the Java application; and
formatting the identified Java class files to generate a validation API attribute list;
wherein comparing the API attribute list comprises comparing the validation API attribute list to the list of Java class files supported by the mobile terminal to determine if the mobile terminal supports the Java application.

5. The method of claim 4, wherein identifying all Java class files associated with the Java application comprises:
identifying all Java class files contained in the Java application; and
identifying all Java class files referenced in the Java class files contained in the Java application.

6. The method of claim 5, wherein formatting the identified Java class files to generate a validation API attribute list comprises generating the API attribute list to identify the referenced Java class files without identifying the Java class files contained in the Java application.

7. The method of claim 5 wherein the descriptor comprises a Java Application Descriptor (JAD) and the Java application comprises a Java Archive (JAR) file and wherein identifying all Java class files contained in the Java application comprises identifying all Java class files contained in the JAR file.

8. The method of claim 5, wherein identifying all Java class files contained in the Java application includes generating a list of all Java class files contained in the Java application and wherein identifying all Java class files referenced in the Java class files contained in the Java application is preceded by initializing a list of all required classes and a list of all required bundles to an empty set and wherein formatting the identified Java class files comprises, for each referenced Java class file:
determining if the referenced Java class file is included in the list of all Java class files contained in the Java application;
determining if the referenced Java class file is included in any bundle included in the list of all required bundles when the referenced Java class file is not included in the list of all Java class files contained in the Java application;
determining if the referenced Java class file is included in a bundle known to the mobile terminal when the referenced Java class file is not included in any bundle included in the list of all required bundles;
adding the bundle known to the mobile terminal to the list of all required bundles when it is determined that the referenced Java class file is included in the bundle known to the mobile terminal; and
adding the referenced Java class file to the list of all required classes when it is determined that the identified Java class file is not included in any bundle included in the list of all required bundles or in a bundle known to the mobile terminal or in the list of all Java class files contained in the Java application; and
wherein formatting the identified Java class files further comprises generating the validation API attribute list based on the list of required bundles and the list of required classes.

9. The method of claim 8, wherein the list of required bundles and/or the list of known bundles includes an identification of Java packages.

10. The method of claim 8, wherein the referenced Java class files have an associated version and wherein adding the referenced Java class file to the list includes adding an identification of the associated version and wherein determining if the referenced Java class file is included in any bundle included in the list of all required bundles and determining if the referenced Java class file is included in a bundle known to the mobile terminal are based on the associated version.

11. The method of claim 10, wherein adding an identification includes adding a method type signature associated with the referenced Java class file.

12. The method of claim 8 wherein the descriptor comprises a Java Application Descriptor (JAD) and the Java application includes a Java Archive (JAR) file and wherein identifying all Java class files contained in the Java application includes inspecting a constant pool field, a super class field and an interfaces field of all Java class files contained in the JAR file.

13. The method of claim 8, wherein the identified Java class files are identified as optional or required and wherein downloading the Java application when the mobile terminal supports the Java application comprises automatically downloading the Java application when the mobile terminal supports all the required and all the optional identified Java class files and wherein downloading the Java application when the mobile terminal supports all the required identified Java class files and less than all the optional identified Java class files includes notifying the user of the mobile terminal that the Java application may be downloaded with limited functionality before downloading the Java application and wherein notifying the user of the mobile terminal that the mobile terminal does not support the Java application comprises notifying the user of the mobile terminal that the mobile terminal does not support the Java application when the mobile terminal supports less than all of the required identified Java class files.

14. The method of claim 8, wherein downloading the Java application when the JAD does not include the API attribute list is preceded by comparing any bundles identified by a field included in the downloaded descriptor to the list of Java class files supported by the mobile terminal and wherein the Java application is not downloaded and the user is notified the mobile terminal does not support the Java application when any bundles identified by the field included in the downloaded descriptor are not included in the list of Java applications supported by the mobile terminal.

15. The method of claim 3, wherein comparing the API attribute list includes determining if any bundles identified by a field other than the API attribute list included in the downloaded descriptor are included in the list of Java class files supported by the mobile terminal to determine if the mobile terminal supports the Java application.

16. The method of claim 3, wherein the list of Java class files supported by the mobile terminal includes at least one bundle identification and the API attribute list includes at least one bundle identification and wherein comparing the API attribute list includes comparing the at least one bundle identified in the API attribute list to the at least one bundle identified in the list of Java class files supported by the mobile terminal.

17. A computer program product for controlling downloading of a Java application to a mobile terminal, the computer program product comprising computer program code embodied in a computer readable medium, the computer program code comprising program code configured to carry out the method of claim 1.

18. A communication system configured to carry out the method of claim 1.

19. A method for generating an API attribute list for a Java application, comprising:
obtaining a list of known bundles that identifies all classes known to the respective known bundles;
initializing a list of all required classes and a list of all required bundles to an empty set;
identifying all Java class files referenced by the Java application; and
formatting the identified Java class files to generate the API attribute list, wherein formatting the identified Java class files includes, for each identified Java class file:
determining if the identified Java class file is contained in the Java application;
determining if the identified Java class file is included in any bundle included in the list of all required bundles when the identified Java class file is not contained in the Java application;
determining if the identified Java class file is known to a listed one of the known bundles in the list of known bundles when it the identified Java class file is not included in any bundle included in the list of all required bundles;
adding the listed one of the known bundles to the list of all required bundles when it is determined that the identified Java class file is known to the listed one of the known bundles and is not contained in the Java application; and
adding the identified Java class file to the list of all required classes when it is determined that the identified Java class file is not included in any bundle included in the list of all required bundles or known to a listed one of the known bundles or contained in the Java application; and
wherein formatting the identified Java class files further comprises generating the API attribute list based on the list of required bundles and the list of required classes.

20. The method of claim 19, wherein identifying all Java class files referenced by the Java application comprises:
identifying the Java class files contained in the Java application; and
identifying all Java class files referenced in the Java class files contained in the Java application.

21. The method of claim 20 wherein the Java application includes a Java Application Descriptor (JAD) and a Java Archive (JAR) file and wherein identifying all Java class files contained in the Java application comprises identifying all Java class files contained in the JAR file and wherein generating the API attribute list is followed by incorporating the API attribute list in the JAD.

22. A computer program product for generating an API attribute list for a Java application, the computer program product comprising computer program code embodied in a computer readable medium, the computer program code comprising program code configured to carry out the method of claim 19.

23. A computer system configured to carry out the method of claim 19.

24. A mobile terminal, comprising:
a user interface configured to receive a user request to download a Java application and to notify a user when the mobile terminal does not support a requested Java application;
a communication interface configured to download the Java application responsive to the user request;
a list of Java class files supported by the mobile terminal; and
a controller configured to identify all Java class files required by the Java application and to control downloading of the Java application based on a comparison of the list of Java class files supported by the mobile terminal with all Java class files required by the Java application, including download the Java application using the communication interface when the list of Java class files supported by the mobile terminal includes all the Java class files required by the Java application and to provide a notification to the user through the user interface when the list of Java class files supported by the mobile terminal does not include all the Java class files required by the Java application.

25. The mobile terminal of claim 24, wherein the controller is configured to identify the Java class files required by the Java application by downloading a descriptor associated with the Java application using the communication interface and retrieving an API attribute list included in the descriptor, the API attribute list identifying all the Java class files required by the Java application.

26. The mobile terminal of claim 24, wherein the controller is configured to download the Java application using the communication interface when the descriptor does not include the API attribute list and to generate the API attribute list from the downloaded Java application.

27. A computer system for generating an API attribute list for a Java application, the system comprising:
a list of known bundles that identifies all classes known to the respective known bundles;
a list of all required classes;
a list of all required bundles;
a required class identification module configured to identify all Java class files referenced by the Java application; and
an API attribute list generation module configured to initializing the list of all required classes and the list of all required bundles to an empty set and to format the identified Java class files by, for each identified Java class file: 1) determining if the identified Java class file is included in any bundle included in the list of all required bundles; 2) determining if the identified Java class file is known to a listed one of the known bundles in the list of known bundles when the identified Java class file is not included in any bundle included in the list of all required bundles; 3) adding the listed one of the known bundles to the list of all required bundles when it is determined that the identified Java class file is known to the listed one of the known bundles and is not a Java class file contained in the Java application; and 4) adding the identified Java class file to the list of all required classes when it is determined that the identified Java class file is not included in any bundle included in the list of all required bundles or known to a listed one of the known bundles or contained in the Java application and to generate the API attribute list based on the list of required bundles and the list of required classes.

28. A Java application file, comprising;
a plurality of Java class files; and
a Java application descriptor file including an identification of all Java class files required by the Java application file that are not otherwise identified in the Java application descriptor file.

29. A Java application file, comprising;
a plurality of Java class files; and
an API attribute list in at least one of the Java class files that identifies Java class files required by the Java application file, including Java class files referenced by at least one other of the Java class files and not by the at least one Java class file including the API attribute list.
